(19) United States
(12) Patent Application Publication
(10) Pub. No.: US 2006/0184314 A1
(43) Pub. Date: Aug. 17, 2006

(54) Multi-modal navigation system and method

(75) Inventors: Jeffrey Darren Couckuyt, Bothell, WA (US); Timothy S. McGrath, Redmond, WA (US); Herry Sutanto, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/058,057

(22) Filed: Feb. 14, 2005

(51) Int. Cl. G01C 21/34

(52) U.S. Cl. 701/202; 701/209; 340/995.19

(57) ABSTRACT

A multi-modal navigation system is presented. The navigation system is multi-modal as it provides navigation information (including routes, maps, directions, and navigation instructions) for a plurality of transportation modes including, but not limited to, automobiles, pedestrian walking, trains, subways, and the like. The multi-modal navigation system may be embodied in integrated navigation devices, as stand-alone navigation systems on a variety of computing devices, as a navigation service on a computing device or as a Web service, and the like. The multi-modal navigation system includes route data for a plurality of transportation modes. Route data for the plurality of transportation modes may be integrated, may be separately available, or any combination thereof.

### FIELD OF THE INVENTION

The present invention relates to navigation systems, and more particularly, to a navigation system and method for providing multi-modal navigation information.

### BACKGROUND OF THE INVENTION

Navigation systems, including integrated navigation devices that are frequently found in vehicles, are useful in providing routing information, driving instructions, and mapping services to a user. Indeed, as most computer users are aware, in addition to integrated navigation devices in vehicles, nearly anyone can go online to numerous Web sites and obtain navigation/driving directions from point A to point B.

Typical navigation systems provide automobile driving instructions. In most cases, the user enters an origin and destination, and the navigation system responds by providing driving directions/instructions to get from the specified origin to the specified destination. Similarly, other navigation systems exist, frequently directed at mass transit. Many mass transit entities provide a some type of navigation system that their customers can use to obtain transit information, or in other words, a type of navigation information. For instance, a user may access a mass transit bus system to query it for information regarding bus stops, both those near the user's residence and the user's destination, schedules, and routes. In response, the mass transit's navigation system returns related bus routes, stops, schedules, and itineraries that the user might use to arrive at, or close to, the specified destination.

Still further, most computer users are aware that one can access air travel information (another form of navigation information) regarding air travel from one city to another. Typically, the user enters both an origin and a destination city or airport, and personal preference items including direct or indirect flights, preferred travel dates and times, seating class, and the like. In response, the reservation system returns one or more itineraries the user may purchase in order to secure the air passage from the origin to destination city. Of course, in regard to air travel, the user must know concerning and specify both origin and destination airports when requesting air travel. However, in many large cities or urban areas, there are several airports that may be used, some of which may or may not be more convenient or less costly to the user, but of which the user is unaware.

As can be seen, there are various navigation systems currently available, but unfortunately, there isn't a navigation system that provides navigation information for multiple transportation modes, i.e., a multi-modal navigation system. The present invention addresses this and other issues found in the prior art.

### SUMMARY OF THE INVENTION

According to aspect of the present invention, a multi-modal navigation system for generation navigation information for a plurality of transportation modes is presented. The multi-modal navigation system comprises multi-modal route data, including route data for a plurality of transportation modes. The multi-modal navigation system also comprises a cost determination module. The cost determination module determines a cost associated with route segments in the multi-modal route data, which is used in determining multi-modal navigation information. The multi-modal navigation system further comprises a routing module that generates multi-modal navigation information according to the multi-modal route data, and also according to the determined costs from the cost determination module.

According to additional aspects of the present invention, a multi-modal navigation Web service for generation navigation information for a plurality of transportation modes is presented. The multi-modal navigation Web service comprises multi-modal route data including route data for a plurality of transportation modes. The multi-modal navigation Web service also comprises a cost determination module. The cost determination module determines a cost associated with route segments in the multi-modal route data, wherein the determined cost is used in determining multi-modal navigation information. The multi-modal navigation Web service further comprises a routing module that generates multi-modal navigation information according to the multi-modal route data, and also according to the determined costs from the cost determination module. The multi-modal navigation Web service still further comprises a navigation system external interface. The navigation system external interface provides Web service access to the multi-modal navigation information generated by the routing module to a client computer connected to the Internet.

According to further aspects of the present invention, A computer-readable medium bearing computer executable instructions which, when executed on a computing device having a process and a memory, configure a computing system to implement a multi-modal navigation system that generates multi-modal navigation information for a plurality of transportation modes is presented. The multi-modal navigation system comprises a cost determination module. The cost determination module determines a cost associated with route segments in multi-modal route data, and the determined cost is used in determining multi-modal navigation information. The multi-modal navigation system also comprises a routing module. The routing module generates multi-modal navigation information on the computing system according to the multi-modal route data, and also according to the determined costs from the cost determination module.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a pictorial diagram illustrating an exemplary networked environment including a multi-modal navigation system and suitable for implementing aspects of the present invention;

FIG. 2 is a pictorial diagram illustrating an exemplary multi-modal navigation system implemented as an integrated, stand-alone device;

FIG. 3 is a pictorial diagram illustrating another networked environment including a multi-modal navigation system, suitable for implementing aspects of the present invention;

FIG. 4 is a pictorial diagram illustrating exemplary logical components of a navigation system adapted according to aspects of the present invention; and

FIG. 5 is a pictorial diagram illustrating exemplary route data, including exemplary route segments, interconnection nodes, and costs associated with route segments.

### DETAILED DESCRIPTION

According to aspects of the present invention, a multi-modal navigation system, i.e., one that provides and combines navigation information for a plurality of transportation modes, is presented. A multi-modal navigation system may be implemented on a variety of computing devices, including a personal computer, laptop or notebook computer, personal digital assistant (PDA), hybrid computing devices including a global positioning system (GPS), mini- and mainframe computers, and the like, as well as implemented as a Web service on the Internet.

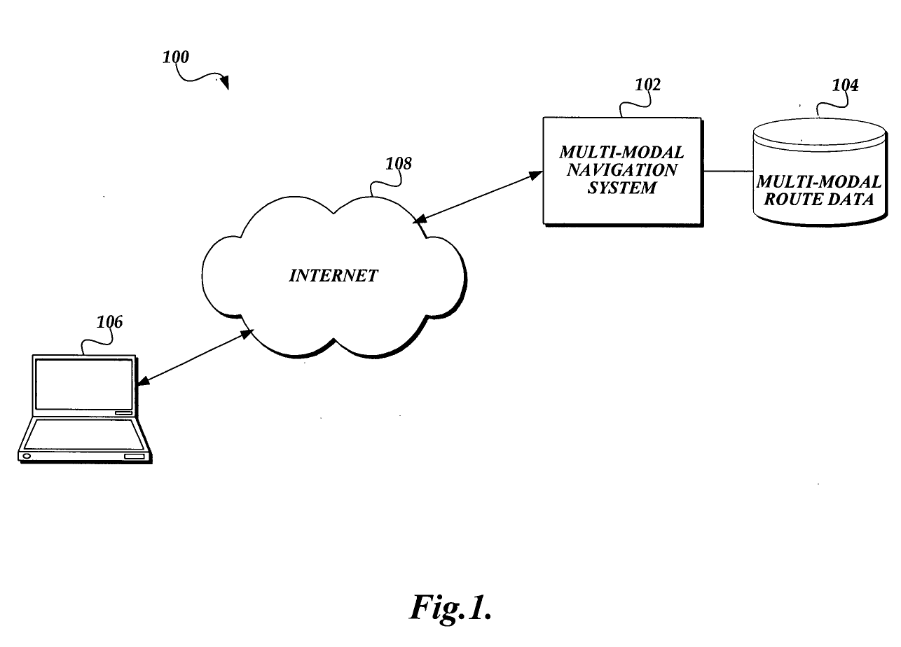

In particular, FIG. 1 is a pictorial diagram illustrating an exemplary networked environment 100 including a multi-modal navigation system 102, adapted according to aspects of the present invention. As illustrated in FIG. 1, the multi-modal navigation system 102 includes, or is associated with, multi-modal route data 104. Multi-modal route data 104 includes route information/data for a plurality of transportation modes, such as pedestrian walkways, automobile roads, mass transit routes, and the like.

In the exemplary networked environment, a user utilizes a computer, such as laptop 106 to connect to the multi-modal navigation system 102 over a network, such as the Internet 108. Through the user's computer, the user typically requests route/navigation information from an origin to a destination. In response, the multi-modal navigation system determines a route from the specified origin and destination using the multi-modal route data, and returns that route to the user's computer.

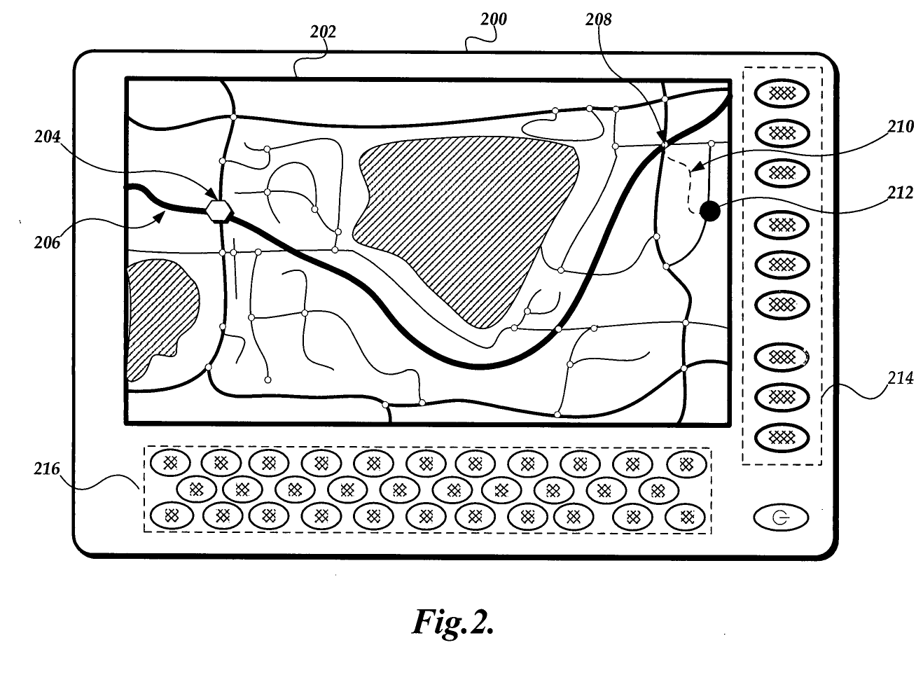

As an alternative of the networked environment 100, FIG. 2 is a pictorial diagram illustrating an exemplary multi-modal navigation system, implemented as an exemplary integrated navigation device 200. As those skilled in the art will appreciate, an exemplary stand-alone navigation device 200 typically includes a display system 202, control buttons 214, and data input buttons 216.

Quite frequently, an exemplary navigation device 200 is configured to show a map of the current position 204 and the immediate surroundings. Additionally, various roads, paths, and other routes, such as road 206 and foot path 210, are displayed on the display system 202. According to the present invention, the exemplary navigation system 200 is configured to display route and navigation information corresponding to a plurality of transportation modes, i.e., is multi-modal. For example, as previously indicated, road 206 may correspond to a public bus route, and foot path 210 may correspond to a walkway through a public park. Junction 208 may indicate a bus stop, in which a user may exit the public bus and walk to a destination 212.

Other information that would be typically included in the exemplary navigation device 200, but not displayed in FIG. 2, includes multi-modal route data describing route data for a plurality of transportation modes. Also frequently included in an exemplary navigation device 200 is a GPS unit, or some other location sensing sub-system.

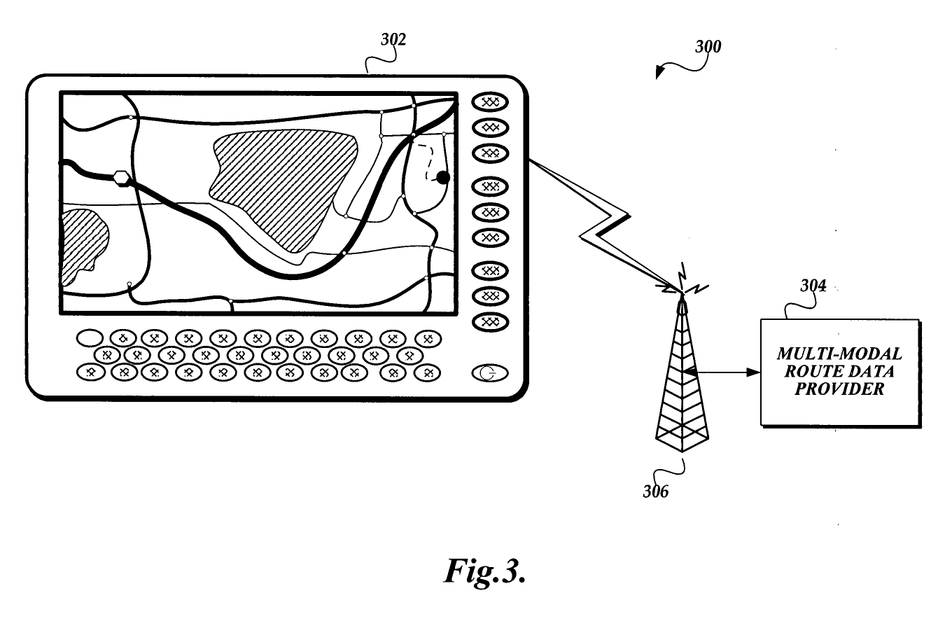

While a navigation system will use multi-modal route data in providing multi-modal navigation information, it is not necessary that the navigation system include such multi-modal data, but could instead have access to such data. FIG. 3 is a pictorial diagram illustrating an alternative exemplary networked environment 300, including a multi-modal navigation device 302, suitable for implementing aspects of the present invention. In this example, while the navigation device 302 may internally cache some multi-modal route data (not shown), in general, the navigation device obtains the multi-modal route data from a route data provider 304. As shown in this exemplary diagram, the route data provider 304 transmits the multi-modal route data to the navigation device 302 via a wireless communication system 306. Of course, the navigation system may alternatively obtain multi-modal route data on media, such as a DVD or CD-ROM disc. Thus, the present invention should not be viewed as limited to any particular embodiment.

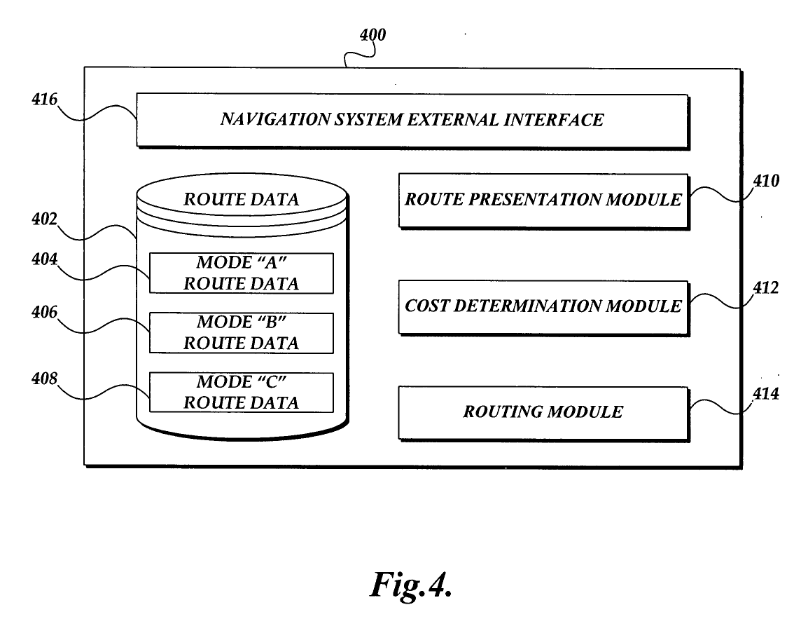

As has been described above, a multi-modal navigation system may be configured in a variety of embodiments. However, several components of a multi-modal navigation system are found in common among all of the various embodiments and/or configurations. Accordingly, FIG. 4 is a pictorial diagram illustrating exemplary logical components of a multi-modal navigation system adapted according to aspects of the present invention. As logical components, it should be understood that the subsequently described components may be combined with, or divided into, other actual components of a navigation system. Additionally, it should be understood that other components not described herein may be included in an exemplary navigation system.

As shown in FIG. 4, the exemplary navigation system 400 may include multi-modal route data 402 comprising route data and information for a plurality of transportation modes. As illustrated in FIG. 4, the multi-modal route data 402 includes information corresponding to transportation mode A 404, mode B 406, and mode C 408. These transportation modes may correspond to automobile, bus, and foot route data. Of course, other modes may also be present in the multi-modal route data 402.

While the illustrative FIG. 4 indicates that route data for each individual transportation mode is stored separately from route data of other modes, it should be appreciated that such separation is logical only, and should be viewed as illustrative only, and should not be construed as limiting upon the present invention. In an actual embodiment (not shown), route data of a plurality of transportation modes may be integrated into a single, integrated route data store.

Route data typically comprise route segments of available routes (e.g., roads, paths, rail lines, bus routes, ferry routes, etc.), costs associated with route segments, inter-connections between route segments, and other data associated with route segments and routes generally. Route segments are typically described in terms of the geometry of the route segment. Costs may be expressed in terms of a monetary cost, but also may comprise a route segment traversal cost, a route segment distance cost, a route segment traversal time cost, and the like. Other information that may be stored in the multi-modal route data, including some values that may be viewed and/or evaluated as costs, include information such as route headings, street names, speed limits, schedules and/or arrival times, and the like.

In addition to describing route segments, route geometry, and inter-connections, multi-modal route data may be organized in a hierarchical manner for efficient route determination. A greater description of hierarchically organized route data, and the benefits that flow from such an organization, is described in greater detail in pending patent application entitled “Efficient Navigation Routing System and Method,” Attorney Docket No. MSFT-1-23857, filed ______, which is incorporated herein by reference.

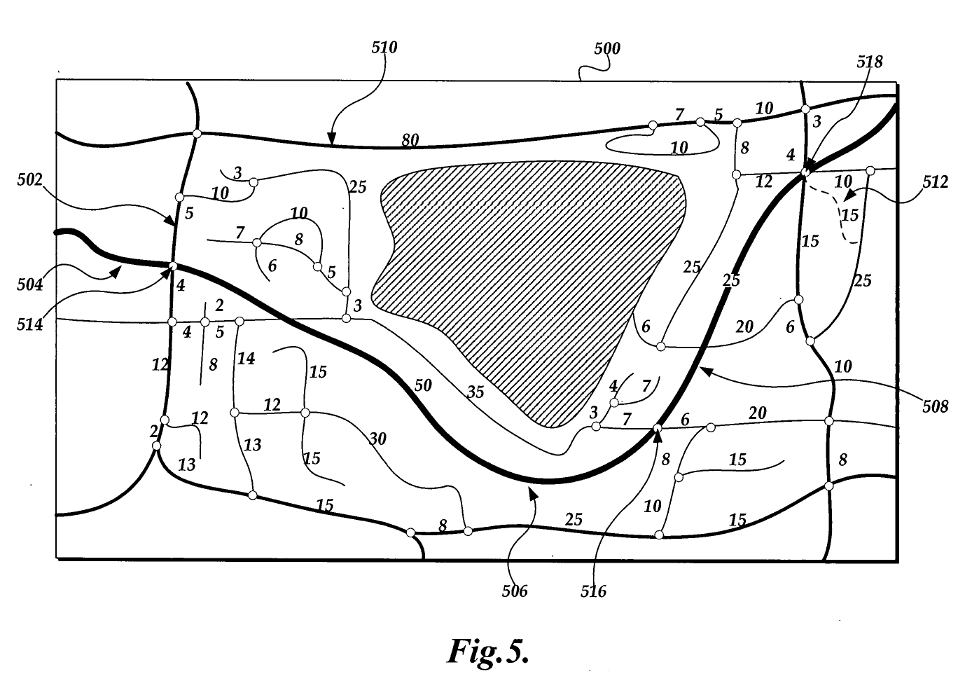

With regard to route data, FIG. 5 is a pictorial diagram illustrating exemplary route data, including exemplary route segments, interconnection nodes, and costs associated with route segments. It should be noted that the exemplary route data is layed out in a map-like format for illustration purposes for describing the route data, and does not represent the actual storage format of route data.

As shown in FIG. 5, route data comprises smaller route segments, such as route segments 502, 504, 506, 508, 510, and 512. Route segments are connected to other route segments at inter-connection points, referred to hereafter as nodes. Nodes, in exemplary FIG. 5, are identified as circles between route segments, such as nodes 514, 516, and 518. Nodes represent a wide variety of interconnections including, but not limited to, street intersections, bus stops, subway and or train terminals, turnabouts, and the like.

Route segments are associated with one or more cost values, as described above. With regard to FIG. 5, many of the route segments are displayed with a single cost for traversing that route segment. For example, with regard to route segment 506, this segment (between nodes 514 and 516) is associated with a cost value of “50.” Of course, those skilled in the art will appreciate that this cost, without more, may correspond to any number of factors, such as amount of time it takes to traverse the route segment, the length of the route segment, the maximum speed associated with that route segment, the monetary cost to traverse that segment, and the like.

The exemplary route data 500 of FIG. 5 also suggests that this route data is multi-modal, i.e., includes routes for more than one transportation mode. For example, the route comprising route segments 504, 506, and 508 may correspond to a subway or elevated rail line, with nodes 514, 516, and 518 representing passenger terminals. Furthermore, route segments 502 and 510, as well as many others, may correspond to automobile roads, and route segment 512 may correspond to a pedestrian walkway, such as through a public park from the passenger terminal 518.

The presentation module 110 is used to display maps, routes, itineraries, navigation directions, and the like. The route presentation module 110 may be an integrated display device, or alternatively, may be a communication channel to an external object. In an alternative embodiment, the route presentation module is not a necessary module if used in conjunction with the external interface 116 as described below.

With reference again to FIG. 4, also included in the exemplary navigation system 400 is a cost determination module 412. The cost determination module 412 is used to determine and/or evaluate costs associated with each route segment. As already indicated, route segment costs may be expressed as, but not limited to, traversal time, distance, scenic value, monetary costs, and the like. Costs may also be expressed as a preferred mode of travel, time of travel, and fare classifications. Still further, costs may be evaluated as a combination of various cost factors. Other costs may be expressed as a cost-related value associated with transferring from one transportation mode to another.

According to one embodiment, the cost determination module 412 is user configurable, such that costs are further determined or weighted according to criteria specified by the user. For example, a user may configure the cost determination module to evaluate/determine an overall cost for a route segment favoring fare classification, cost, scenic value, or direct route. Thus, a user configured cost determination module 412 may determine an overall cost for a route segment differently than an unconfigured cost determination module.

The cost determinations generated by the cost determination module 412 are used by the routing module 414 in its function to determine a route between an origin and a destination. In other words, the cost determination module 412 obtains cost data for each route segment from the route data 402, determines a cost determination for the route segments, and supplies that cost determination to the routing module 414. The cost determination module 412 will typically determine a cost for a route segment at the direction of the routing module 414.

As already mentioned, the routing module 414 determines a route, according to the route data 402, between an origin and a destination. With regard to the navigation system 400 in general, the routing module 414 may use almost any type of routing algorithm to determine a route between the origin and destination. For example, in one embodiment, the routing module 414 implements Dijkstra's Algorithm, formulated by Edsger W. Dijkstra, which, as those skilled in the art will recognize, uses a double buck approach to determining a best route between and an origin and a destination. A greater explanation of Dijkstra's Algorithm may be found on the Web at http://www.kvocentral.com/kvopapers/pollitt.pdf.

Those skilled in the art will appreciate that there are many improved routing algorithms based on Dijkstra's Algorithm. These improved routing algorithms may also be implemented in the routing module 414. For example, a common improvement on Dijkstra's Algorithm is referred to as the A* Algorithm. The A* Algorithm improves upon the efficiency of Dijkstra's Algorithm by providing guesses as to which route segments should be considered over others. In an actual embodiment, the routing module 414 implements an A* Algorithm as described in the above incorporated reference, “Efficient Navigation Routing System and Method.”

As the navigation system 400 is “agnostic” to the algorithm, or algorithms, implemented by the routing module 414, according to one embodiment of the present invention, the routing module 414 is implemented as a plug and play module with respect to the navigation system. Furthermore, according to an alternative embodiment, the navigation system 400 may include a plurality of routing modules (not shown.)

The navigation system 400 may also include an optional navigation system external interface 416. The navigation system external interface 416 enables the navigation system 400 to be accessible in or by another product, especially when the navigation system 400 is configured/embodied on a computing device, such as a personal computer or Web service. For example, through the navigation system external interface 416, the navigation system 146 may operate as a navigation service providing navigation information to external programs or modules. In this sense, the navigation system external interface 416 may be viewed and configured as an application programming interface (API) to other programs or modules. Similarly, the navigation system external interface 416 may operate as a Web service on an Internet site. It should be appreciated, that when the navigation system external interface 416 operates as a navigation service, either to other program modules on a computer or as a Web service to client computers, the route presentation module 410 may be an optional module to the overall navigation system 400.

When the navigation system 400 is configured in an integrated navigation device, or operates as a stand-alone navigation system on a computing device, the navigation system external interface 416 could be excluded from the navigation system, as it is understood that the remaining components of the navigation system are configured to communicate among themselves as necessary.

While various embodiments, including the preferred embodiment, of the invention have been illustrated and described, it will be appreciated that various changes can be made therein without departing from the spirit and scope of the invention.

The embodiments of the invention in which an exclusive property or privilege is claimed are defined as follows:

1. A multi-modal navigation system for generation navigation information for a plurality of transportation modes, the system comprising:
multi-modal route data including route data for a plurality of transportation modes;
a cost determination module that determines a cost associated with route segments in the multi-modal route data, wherein the determined cost is used in determining multi-modal navigation information; and
a routing module that generates multi-modal navigation information according to the multi-modal route data, and also according to the determined costs from the cost determination module.

2. The multi-modal navigation system of claim 1 further comprising a navigation system external interface for providing access to the multi-modal navigation information generated by the navigation system to external objects.

3. The multi-modal navigation system of claim 2, wherein the navigation system external interface is an application programming interface (API) and the external objects are software modules external to the multi-modal navigation system.

4. The multi-modal navigation system of claim 2, wherein the navigation system external interface is a Web service and the external objects are client computers connected to the Internet.

5. The multi-modal navigation system of claim 1 further comprising a route presentation module for presenting the multi-modal navigation information generated by navigation system.

6. The multi-modal navigation system of claim 5, wherein the navigation system is an integrated navigation device.

7. The multi-modal navigation system of claim 1, wherein the routing module implements an A* Algorithm in generating multi-modal navigation information.

8. The multi-modal navigation system of claim 1, wherein the routing module is a plug-and-play module such that a routing module implementing any routing algorithm may be used.

9. The multi-modal navigation system of claim 1, wherein route data comprises route segments, interconnections between route segments, and at least one cost value associated with each route segment.

10. The multi-modal navigation system of claim 9, wherein the cost determination module determines an overall cost for a first route segment according to the at least one cost value associated with the first route segment, and provides that overall cost to the routing module for generating multi-modal navigation information.

11. The multi-modal navigation system of claim 10, wherein the at least one cost associated with each route segment comprises at least one of a cost value for the time to traverse the route segment, the distance of the route segment, the monetary cost to traverse the route segment, the scenic value of the route segment, and the desirability to traverse the route segment.

12. The multi-modal navigation system of claim 1, multi-modal route data including route data for a plurality of transportation modes including automobiles, pedestrian traffic, subways, railway transportation, bus transportation, and air transportation.

13. A multi-modal navigation Web service for generation navigation information for a plurality of transportation modes, the Web service comprising:
multi-modal route data including route data for a plurality of transportation modes;
a cost determination module that determines a cost associated with route segments in the multi-modal route data, wherein the determined cost is used in determining multi-modal navigation information;
a routing module that generates multi-modal navigation information according to the multi-modal route data, and also according to the determined costs from the cost determination module; and
a navigation system external interface that provides Web service access to the multi-modal navigation information generated by the routing module to a client computer connected to the Internet.

14. A computer-readable medium bearing computer executable instructions which, when executed on a computing device having a process and a memory, configure a computing system to implement a multi-modal navigation system that generates multi-modal navigation information for a plurality of transportation modes, the multi-modal navigation system comprising:
a cost determination module that determines a cost associated with route segments in multi-modal route data, wherein the determined cost is used in determining multi-modal navigation information;
a routing module that generates multi-modal navigation information on the computing system according to the multi-modal route data, and also according to the determined costs from the cost determination module.

15. The computer-readable medium of claim 14 further including a data store area, the data store area storing the multi-modal route data.

16. The multi-modal navigation system of claim 14, wherein the multi-modal navigation system is further configured to obtain the multi-modal route data from an external multi-modal route data provider.

17. The multi-modal navigation system of claim 16, wherein the multi-modal navigation system is further configured to obtain the multi-modal route data from the external multi-modal route data provider over a wireless connection.

18. The multi-modal navigation system of claim 16, wherein the multi-modal navigation system is further configured to include a route presentation module for presenting the generated multi-modal navigation information.

19. The multi-modal navigation system of claim 16, wherein the multi-modal navigation system is further configured to include a navigation system external interface for providing an interface to the navigation system to external objects.

20. The multi-modal navigation system of claim 16, wherein the navigation system external interface is a Web service to client computers connected to the Internet.
